(19) United States
(12) Patent Application Publication
(10) Pub. No.: US 2010/0222244 A1
(43) Pub. Date: Sep. 2, 2010

(54) LUBRICATING COMPOSITIONS BASED ON PERFLUOROPOLYETHERS

(76) Inventors: Patrizia Maccone, Milano (IT); Giovanni Boccaletti, Mantova (IT)

Correspondence Address: ARENT FOX LLP, 1050 CONNECTICUT AVENUE, N.W., SUITE 400, WASHINGTON, DC, 20036, US

(21) Appl. No.: 12/160,527

(22) PCT Filed: Jan. 11, 2007
(86) PCT No.: PCT/EP2007/050245

§ 371 Date: Jul. 10, 2008

(30) Foreign Application Priority Data
Jan. 17, 2006 (IT) M12006A 000066

(51) Int. Cl. C10M 169/00; C08K 5/06

(52) U.S. Cl. 508/112; 508/582; 508/154; 508/155; 524/366

(57) ABSTRACT

Use as additive to stabilize perfluoropolyether lubricant oils at high temperatures, preferably higher than 200° C., of a solid polymer at room temperature, having a softening or a melting point higher than 150° C., preferably higher than 200° C., and containing in the repeating unit at least one aromatic ring; preferably in the backbone, and lubricating compositions containing said additive.

The present invention relates to the use of non fluorinated aromatic polymers as additives for fluorinated lubricants.

More specifically the present invention relates to fluorinated lubricant compositions having improved thermal stability at high temperatures in oxidizing environment and in the presence of metals, in particular at temperatures higher than 200° C.

In particular the present invention relates to the use of polymers containing aromatic rings as additives to stabilize perfluoropolyether oils in lubricant compositions at high temperatures in oxidizing environment and in the presence of metals, preferably at temperatures higher than 200° C.

It is known that perfluoropolyether oils (PFPE) at high temperatures in the presence of metals and in oxidizing environment suffer degradative processes causing the break of the perfluoropolyether chains producing volatile products. Therefore the loss of the lubricating performances of the perfluoropolyether oil or of the grease containing the perfluoropolyether oil occurs.

For overcoming this drawback numerous known additives in the prior art are generally used to stabilize the perfluoropolyether oils at high temperatures in oxidizing environment and in the presence of metals thus guaranteeing their stability during the use.

The stabilizing additives for perfluoropolyether oils are generally fluorinated compounds and contain in their molecule fluorinated chains, preferably perfluoropolyether chains, in order to be solubilized and/or dispersed in the perfluoropolyether oils. Some examples of said known additives of the prior art can be mentioned.

U.S. Pat. No. 4,681,693 describes soluble stabilizers having a structure formed of arylphosphines, or their derivatives, for perfluoropolyether lubricants or perfluoropolyether containing greases.

EP 597,369 describes perfluoropolyether-based phosphazene derivatives stabilizers for perfluoropolyether oils.

Patent application US 2003/0203823 describes perfluoropolyethers having dinitroaryl end groups or stabilizers for fluorinated lubricants.

The prior art fluorinated additives are liquid and generally are used in fluorinated lubricating compositions in amounts generally ranging between 1% and 10% by weight. The higher the additive amount the higher the stabilization in the time and thus higher the lubricant life. The amount of additive is about 1% by weight in the applications wherein the part to be lubricated can be subjected to high peak temperatures for short times but the service temperature is not particularly high. For more severe applications wherein a continued use at high temperatures, higher than 200° C., is required, it is necessary to increase the additive amount, generally to values higher than about 5% by weight.

The drawback of using liquid stabilizing additives in high amounts in the preparation of fluorinated greases resides in that the ratios between the liquid component of the grease (the oil plus additive) and the solid component of the grease (the thickener) are changed. High amount increase of the liquid causes an increase of the liquid separation from the solid as the temperature increases, thus changing the initial grease consistency. The oil separation becomes significant at temperatures higher than 200° C. Furthermore, as the working temperatures increase, the liquid additives tend to evaporate more easily.

The need was felt to have available additives for fluorinated lubricants, in particular perfluoropolyether lubricants showing the following combination of properties:
capability to stabilize perfluoropolyether oils and perfluoropolyether-based greases at high temperatures in oxidizing envrironment and in the presence of metals, preferably at temperatures higher than 200° C.;
reduction of the separation of the fluorinated oil in greases;
solid at service temperature.

The Applicant has unexpectedly and surprisingly found particular additives capable to solve the above technical problem.

An object of the present invention is the use of a solid polymer at room temperature having a softening or a melting point higher than 150° C., preferably higher than 200° C., and containing in repeating unit at least one aromatic ring, preferably in the backbone, as additive to stabilize fluorinated lubricants, preferably perfluoropolyether oils at high temperatures, preferably higher than 200° C.

The aromatic polymer is preferably selected from non fluorinated polymers, solid at room temperature, having a softening or a melting point higher than 200° C. and containing in the repeating unit at least one aromatic ring, optionally substituted. The polymer can be selected for example from the following classes:
(a) polyarylensulphides, among which it can for example be mentioned:

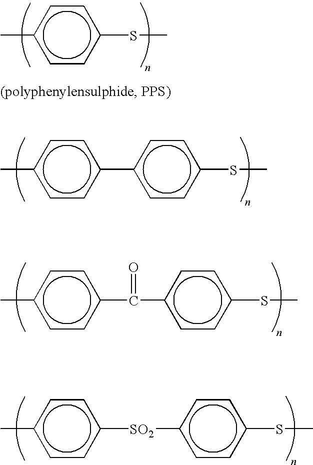

PPS is preferably used.
These products are commercially available or can be prepared according to known techniques of the prior art, see as a reference “Encyclopedia of Polymer Science”, Chapter 32, pages 543-560.
(b) Polyphenylenoxides, among which it can for example be mentioned:

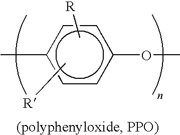

wherein R and R′ are equal to or different from each other and can be H, CH₃ or C₆H₅.
These products are commercially available or can be prepared according to known techniques of the prior art, see as reference “Encyclopedia of Polymer Science”, Chapter 28, pages 473-481.
(c) Polyarylketones, among which it can for example be mentioned:

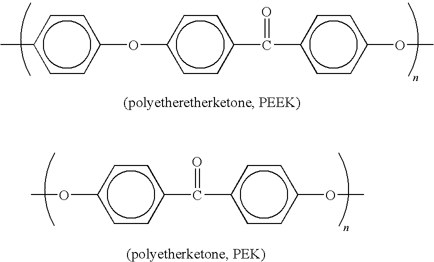

These products are commercially available or can be prepared according to known techniques of the prior art, see as reference “Encyclopedia of Polymer Science and Engineering”, volume 12, pages 313-319; vol.6, pages 103-104.
(d) Polyarylsulphones, among which it can for example be mentioned:

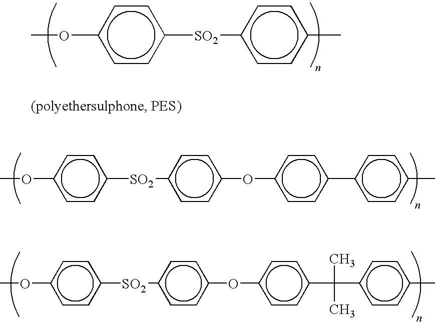

These products are commercially available or they can be prepared according to known techniques of the prior art, see as reference “Encyclopedia of Polymer Science and Engineering”, volume 13, pages 196-197.
(e) Polyamidoimides, among which it can for example be mentioned:

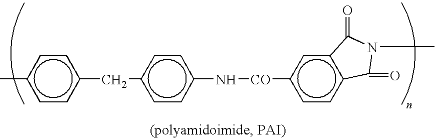

These products are commercially available or they can be prepared according to known techniques of the prior art, see as reference “Encyclopedia of Polymer Science and Engineering”, volume 6, pages 104-105.
(f) Aromatic polyesters and aromatic poly(ester-carbonates), containing repeating units for example of the type

—Ar—COO—; —OCO—Ar—COO—; —Ar—COOR;
wherein the aromatic group Ar can be partially substituted.
Xydar™ marketed by Solvay Advanced Polymers is preferred.
(g) Polyarylamides, polyphthalamides (PPA) for example those having the structure of Nylon 6/6 but with an aryl group instead of the —(CH₂)₄— group in the starting adipic acid, for example Amodel™.

Generally the molecular weight (or the number average molecular weight) of the polymer is in the range 500-100,000, preferably 1,000-50,000, more preferably 1,500-30,000; n is an integer such as to obtain the above molecular weight.

The above polymers are solid at room temperature and are in powder form, having an average size preferably in the range 0.1 μm-1,000 μm, more preferably 50 μm-300 μm, still more preferably 1 μm-30 μm.

It is surprising and unexpected that non fluorinated polymers as defined above, and thus not containing fluorinated chains, in particular perfluopolyether chains, are able to stabilize fluorinated oils, in particular perfluoropolyether oils at high temperatures in the presence of metals in oxidizing environment.

The polymers of the invention are used in amounts between 0.1% and 50% by weight, preferably between 1% and 10% by weight, more preferably between 2% and 7% by weight.

A further object of the present invention are fluorinated lubricant compositions comprising (% by weight):
A) from 99.9% to 50% of a perfluoropolyether oil or mixture of perfluoropolyether oils, having kinematic viscosity at 20° C. between 10 and 4,000 cSt, preferably between 30 and 2,000 cSt and comprising at least one of the following repeating units: —(CFXO)—, wherein X is equal to F, CF₃; —(CF₂CF₂O)—, —(C₃F₆O)—, —(CF₂CF₂CF₂O)—, —(CF₂CF₂₋CF₂CF₂O)— statistically distributed along the polymer backbone;
B) from 0% to 50%, preferably between 5% and 40%, of one or more thickening agents;
C) from 0.1% to 50%, preferably between 1% and 10%, of the above solid polymers object of the present invention; optionally
D) from 0% to 10%, preferably between 1% and 5% based on the total amount of A), B) and C), of at least one additive selected from the known antirust, antiwear, antioxidizing, pour point depressant additives of the prior art;
the sum of A), B), C) and D) is 100% by weight.

Component A) is preferably selected from the following classes:
(1) E-O—(CF₂CF(CF₃)O)_{m′}(CFXO)_{n′}—CFXO-E′
   wherein:
   X is equal to F or CF₃;
   E and E′, equal to or different from each other, are selected from CF₃, C₂F₅ or C₃F₇, one fluorine atom of one or both the end groups can be substituted by Cl and/or H;
   m′ and n′ are integers such that the ratio m′/n′ is between 20 and 1,000, n′ being different from zero; the fluorooxyalkylene units being statistically distributed along the chain and the viscosity of the polymer being in the above range.
   These polymers can be obtained by photooxidation of perfluoropropene as described in GB 1,104,432 and subsequent conversion of the end groups as described in GB 1,226,566.
(2) C₃F₇O(CF(CF₃)CF₂O)_{o′}-D
   wherein:
   D is equal to —C₂F₅ or —C₃F₇, one fluorine atom of one or both the end groups can be substituted by Cl and/or H;
   o′ is an integer such that the viscosity of the polymer is in the above range.
   These polymers can be prepared by ionic oligomerization of the perfluoropropylenoxide and subsequent treatment with fluorine as described in U.S. Pat. No. 3,242,218.
(3) {C₃F₇O(CF(CF₃)CF₂O)_{p′}—CF(CF₃)—}₂
   wherein:
   p′ is an integer such that the viscosity of the polymer is in the above range, one F atom of one or both the end groups C₃F₇ can be substituted by Cl and/or H.
   These polymers can be obtained by ionic telomerization of the perfluoropropylenoxide and subsequent photochemical dimerization as reported in U.S. Pat. No. 3,214,478.
(4) E-O—(CF₂CF(CF₃)O)_{q′}(C₂F₄O)_{r′}(CFXO)_{s′}—CFXO-E′
   wherein:
   X is equal to F or CF₃;
   E and E′, equal to or different from each other, are as above;
   q′, r′ and s′ are integers, including zero, and such that the viscosity of the polymer is in the above range.
   These polymers are obtainable by photooxidation of a mixture of C₃F₆ and C₂F₄ and subsequent treatment with fluorine as described in U.S. Pat. No. 3,665,041.
(5) E-O—(C₂F₄O)_{t′}(CF₂O)_{u′}—CF₂O-E′
   wherein:
   E and E′, equal to or different from each other, are as above;
   t′ and u′ are integers such that the t′/u′ ratio is between 0.1 and 5; u′ being different from zero and the viscosity of the polymer being in the above range.
   These polymers are obtained by C₂F₄ photooxidation as reported in U.S. Pat. No. 3,715,378 and subsequent treatment with fluorine as described in U.S. Pat. No. 3,665,041.
(6) E-O—(CF₂CF₂CF₂O)_{v′}-E′
   wherein:
   E and E′, equal to or different from each other, are as above;
   v′ is an integer such that the viscosity of the polymer is in the above range.
   These polymers are obtained as described in EP 148,482.
(7) D-O—(CF₂CF₂O)_{z′}-D′
   wherein:
   D and D′, equal to or different from each other, are selected between C₂F₅ or C₃F₇, one fluorine atom of one or both the end groups can be substituted by Cl and/or H;
   z′ is an integer such that the viscosity of the polymer is in the above range.
   These polymers can be obtained as reported in U.S. Pat. No. 4,523,039.
(8) E₁-O—(CF₂O)ₙ(CF₂CF₂O)ₘ(CF₂CF₂CF₂O)ₚ(CF₂CF₂CF₂CF₂O)_{q}—CF₂O-E₂
   wherein:
   E₁ and E₂ are perfluoroalkyl end groups equal to or different from each other, having formula —(CF₂)_{z}CF₃ wherein z is an integer from 0 to 3;
   n, m, p, q are integers, equal to or different from each other, between 0 and 100 and selected so that the viscosity of the polymer is in the above range and such that the m/n ratio is between 2 and 20, when n is different from zero;
   (p+q)/(m+n+p+q) is between 0.05 and 0.2 when (m+n+p+q) is different from zero; n/(n+m+p+q) is between 0.05 and 0.40 when (n+m+p+q) is different from zero.
   These polymers can be obtained according to EP 1,454,938.

The preferred perfluoropolyether oils are those of the classes (1), (4), (5), (8) or their mixtures and are available on the market with the trademark FOMBLIN® and marketed by Solvay Solexis S.p.A.

Component B), when present, can be selected from the thickneners known in the prior art for perfluoropolyether oils, for example talc, silica, boron nitride, PTFE, or mixtures thereof. When silica is used, the amounts generally range from 1% to 10% by weight with respect to the total of the composition; when talc, boron nitride or PTFE are used, the amounts can range from 5% to 40% by weight with respect to the total, more preferably from 5% to 35%.

Preferably PTFE in powder is used as component B), more preferably PTFE having an average particle size between 0.01 μm and 0.3 μm. The PTFE can be obtained by the known polymerization techniques, in particular by microemulsion, emulsion or dispersion. Furthermre, it can also be subjected to irradiation. Known processes for preparing said polymer are described in patent application US 2005/0075250 and in patents U.S. Pat. No. 4,864,006, U.S. Pat. No. 6,297,334, U.S. Pat. No. 6,576,703.

Component C) is the above defined aromatic polymer. The above polymers of the classes from (a) to (g) are marketed by Solvay Advanced Polymers (SAP).

The amount of component C) preferably ranges from 0.1% to 10% by weight, more preferably from 2% to 7% with respect to the perfluoropolyether oil, when it is used as additive in the lubricant compositions. Component C) can be present in larger amounts, up to 50% when it is used in greases not containing thickeners.

Component D) is preferably selected from the known additives of the prior art, for example it can be mentioned, as antiwear additives, molybdenum sulphide, molybdenum organic compounds, boron nitride, graphite, phosphazene derivatives, in particular phosphazene derivatives as those described in U.S. Pat. No. 5,124,058 and in patent application US 2003/0176738 in the name of the Applicant. As antirust additives, the disodic sebacate, functionalized derivatives of carboxylic acids, as described in U.S. Pat. No. 6,025,307, can be mentioned.

The compositions of the present invention can be in the form of oils or greases.

The lubricant compositions of the present invention are prepared according to the prior art procedures.

A preferred embodiment for preparing a grease comprises the following steps:
charging of the oil and/or mixture of lubricating oils in a mixer and degassing under vacuum at 60° C. for 2 hours at 0.1 mbar;
gradual addition of components B) and C), previously mixed, until reaching the desired composition;
optional addition of component D);
stirring for at least 8 hours under vacuum;
discharge of the obtained mixture and its refining by passage on tricylindrical refiner.

When component D) is liquid, it is premixed in the oil(s) before the addition of the solid components B) and C); when component D) is solid, it is premixed with components B) and C).

The grease obtained by the present process is ready to be used.

The grease consistency depends on the total concentration of B) and C). As a matter of fact, by suitably using B) and C) in the above concentration ranges, all the greases of the penetration NLGI classes can be obtained, as defined in the ASTM D217 method.

The lubricating compositions of the present invention show an improved thermal stability, in particular in applications where a continuous service temperature higher than 200° C., in the presence of metals and in oxidizing environment, is required.

As said, the lubricating compositions of the invention can be in the form of oils or greases. The Applicant has indeed surprisingly and unexpectedly found that component C) is also able to thicken the perfluoropolyether oils. As a matter of fact, when component B) is absent, the compositions of the present invention are under the form of greases when C) is in amounts higher than 10%.

Besides, tests carried out by the Applicant have shown that the fluorinated greases obtained from the components A) and C) show an improved combination of properties, that is a higher thermal stability in combination with a lower oil separation, in comparison with known fluorinated greases obtained from components A) and B), the penetration being the same (see the comparative Examples). In particular A) plus C) compositions show, besides an improved thermal stability in the presence of metals at high temperatures and a lower oil separation, also an improved wear value with low and high loads and an improved resistance to corrosion in comparison with the compositions obtained from A) and B) (see the Examples).

Component C) can also be a polymer having a low number molecular weight polymer (oligomer), generally lower than 500, and thus appearing in the form of a liquid. Also in this case the additive C) is capable to stabilize the perfluoropolyether oil in oxidizing environment and in the presence of metals when used in grease compositions.

Some illustrative but not limitative Examples of the invention follow.

### EXAMPLES

### Characterization

Penetration
The test is carried out according to the ASTM D 217 standard.

Thermooxidative Stability Test in the Presence of Metals
45 g of a composition of the invention to be tested are added with 5 g of iron filings by mechanical stirring.
The so prepared composition is deposited by a stratifying knife in a glass capsule having a 95 mm diameter, so as to uniformly cover the whole exposed surface. The capsule is then placed in a drier for 30′, then weighed and put in stove at a determined temperature (>200° C.). After a predetermined time the capsule is taken off from the stove and it is allowed to cool in the drier. The capsule is then weighed again and the percent weight loss with respect to the initial weight is evaluated.
The test result is thus expressed as percent weight loss with respect to the initial weight (ΔP %).

Oil Separation
The oil separatin is determined according to the FMTS 791-321 method at 204° C. for 30 h.

Four-Ball Wear Test
The test is carried out according to the ASTM D2266 standard, by using a 40 kg_{f} load at 75° C. for 1 hour.

Estreme-Pressure Four-Ball Wear Test
The test is carried out according to the ASTM D 2596 standard. The test supplies a series of data concerning the performances of the lubricants tested under a high load ranging from 40 kg_{f} to 794 kg_{f}.
The Weld Point (WP), or welding point, is particularly significant: it represents the load corresponding to the welding of the four metal balls used in the test and thus to their mechanical yielding due to the local overheating generated by their friction.

Emcor Test
This method has the purpose to evaluate the lubricant properties to inhibit the rust. It has been carried out according to the ASTM D 6138 standard. The test considers six classifications of the corrosion degree: from class 0 (no corrosion) to class 5 (corrosion area >10% of the total area).

### Example 1

A composition of the invention is prepared by mixing 332.5 g of component A) formed of a perfluoroplyether oil of class (5), commercially known as Fomblin® M30, 142.5 g of component B) formed of PTFE in powder, commercially known as Algoflon® L206, and 25 g of powder of component C) formed of the polymer of the class a) having the following structure:

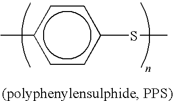

with n=74, having a first melting temperature of 280.5° C.

A homogeneous grease is obtained which shows a penetration value of 285 mm/10′.

The grease is then subjected to the thermooxidative stability test in the presence of metals carried out at 250° C.

After 24 h a percent weight loss of 1.5% is determined. After 72 h a loss of 2.1% is determined.

The oil separation test resulted equal to 7.4% by weight.

### Example 2 (Comparative)

The Example 1 is repeated, wherein at the place of component C), 25 g of the stabilizing additive having a perfluoropolyether basis described in the Example 1 of patent application US 2003/203,823, are used, of formula

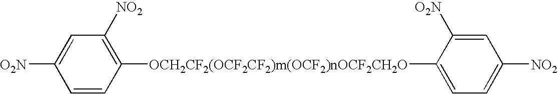

wherein the number average molecular weight of the perfluoroplyether chain is 1,996 and m/n=1.2.

A homogeneous grease is obtained showing a penetration value of 290 mm/10′.

The grease is then subjected to the thermooxidative stability test in the presence of metals carried out at 250° C. After 24 h a percent weight loss of 0.1% is determined. After 72 h a loss of 0.3% is determined.

The oil separation test resulted equal to 9.5% by weight.

### Example 3 (Comparative)

The Example 1 is repeated, without component C).

A homogeneous grease showing a penetration value of 287 mm/10′ is obtained.

The grease is then subjected to the thermooxidative stability test in the presence of metals carried out at 250° C. After 24 h a loss of 48.2% is determined. After 72 h a loss of 58%, corresponding to the almost total loss of component A) is determined.

The oil separation test resulted equal to 7.5% by weight.

The comparison of the data relating to the oil separation of the Examples 1-3 shows that, the penetration being equal, the perfluoropolyether greases of the present invention containing solid stabilizing additives show a good stability in combination with a lower basic oil separation in comparison with the known greases containing liquid stabilizing additives; besides, said reduced separation results comparable with the separation occurring in the greases as such, that is not containing additives.

### Example 4

The Example 1 is repeated, wherein component C) is selected in the class (b) and corresponds to the poly(2,6-diphenyl-1,4-phenylenoxide), having melting point of 460° C., commercially known as Tenax®-TA 80/100.

A homogeneous grease showing a penetration value of 278 mm/10′ is obtained.

The grease is then subjected to the thermooxidative stability test in the presence of metals carried out at 250° C. After 24 h a percent weight loss of 1.3% is determined.

Furthermore the oil separation test resulted equal to 6.4% by weight.

### Example 5

The Example 4 is repeated, wherein component C) is selected in the class (b) and corresponds to the polyphenylenoxide, wherein R═R′═H, commercially known as PPO® SA120, having Mn=2350 and softening point of 210° C.

A homogeneous grease showing a penetration value of 281 mm/10′ is obtained.

The grease is then subjected to the thermooxidative stability test in the presence of metals carried out at 250° C. After 24 h a percent weight loss of 1.6% is determined.

The oil separation test resulted equal to 5.6% by weight.

The comparison of the data of the Examples 4-5 with those of the Example 3 (comparative) shows that the non fluorinated polymers used in the present invention are capable to stabilize the perfluoropolyether lubricants at high temperatures.

Besides the greases of the present invention show a lower oil separation in comparison with the greases not containing any additive, the penetration being equal.

### Example 6

The Example 1 is repeated, wherein component C) is selected in the class (f), commercially known as Xydar® SRT-400, having melting point of about 370° C.

A homogeneous grease showing a penetration value of 282 mm/10′ is obtained.

The grease is then subjected to the thermooxidative stability test in the presence of metals carried out at 250° C. After 24 h a percent weight loss of 0.6% is determined.

The oil separation test resulted equal to 5.9% by weight.

### Example 7

A composition of the invention is prepared by mixing 640 g of component A) formed of a perfluoropolyether oil of class (5), commercially known as Fomblin® M30, and 360 g of component C) formed of the same polymer described in the Example 1.

A homogeneous grease is obtained which is characterized as penetration, oil separation, wear, E.P. 4-ball wear.

The obtained results are the following:
penetration=307 mm/10′;
thermooxidative stability test in the presence of metals at 250° C. for 48 h: loss by weight=3.8%; after 300 h: loss by weight=14%;
oil separation=6.1% by weight;
4-ball wear=0.9 mm;
E.P. 4-ball wear: no welding point (WP) is detected in the load range considered by the test;
Emcor test=2 (corrosion lower than 1% of the total area).

### Example 8 (Comparative)

The Example 7 is repeated, wherein component C) is absent, by using 700 g of the oil of the Example 1 and 300 g of polytetrafluorethylene (PTFE) commercially known as Algoflon® L206.

The so obtained grease has been subjected to the same characterizations reported in the Example 7 and the following results were obtained:
penetration=296 mm/10′;
thermooxidative stability test in the presence of metals at 250° C. for 48 h: weight loss=55%;
oil separation=10.7% by weight;
4-ball wear=1.2 mm;
E.P. 4-ball wear: WP=501 Kg;
Emcor Test: 5 (corrosion area >10% of the total area).

The comparison of the data of the Example 7 with those of the Example 8 (comparatve) shows that the polymer C) of the present invention, besides conferring an improved thermal stability and a lower oil separation, is also able to thicken the perfluooropolyether oils giving rise to greases showing, furthermore, improved wear and corrosion properties in comparison with greases containing PTFE as thickener, the penetration being comparable.

1. Use of a solid polymer at room temperature having a softening or a melting point higher than 150° C., preferably higher than 200° C., and containing in repeating unit at least one aromatic ring, preferably in the backbone, as additive to stabilize fluorinated lubricants, preferably perfluoropolyether oils at high temperatures, preferably higher than 200° C.

2. Use according to claim 1, whereien the solid polymer is selected from non fluorinated polymers, solid at room temperature, having a softening or a melting point higher than 200° C. and contining in the repeating unit at least one aromatic ring, optionally substituted.

3. Use according to claim 1, wherein the polymer is selected from the following classes:
(a) Polyarylensulphides, preferably of formula: 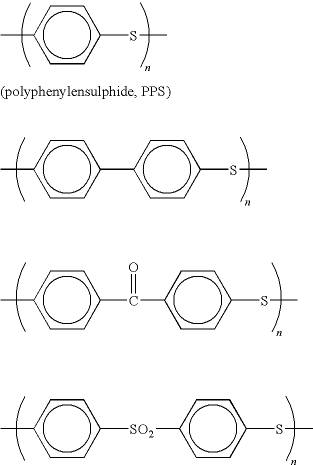
more preferably PPS.
(b) Polyphenylenoxides, preferably of formula: 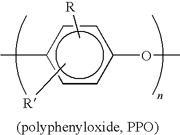
wherein R and R′ are equal to or different from each other and can be H₁ CH₃ or C₆H₅.
(C) Polyarylketones, preferably of formula: 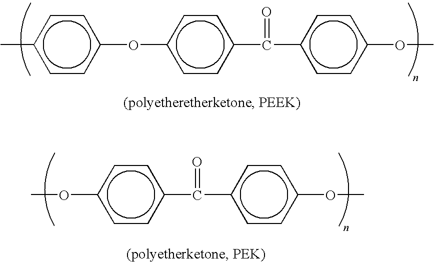
(d) Polyarylsulphones, preferably of formula: 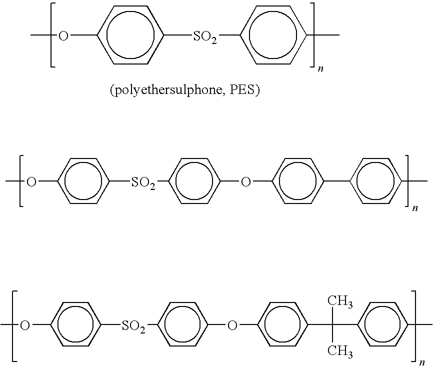
(e) Polyamidoimides, preferably of formula: 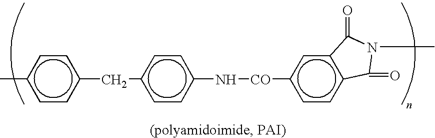
(f) Aromatic polyesters and aromatic poly(ester-carbonates), preferably containing repeating units for example of the type [—Ar—COO—]ₙ; [—OCO—Ar—COO—]ₙ [Ar—COOR]ₙ wherein the aromatic Ar group can be partially substituted.
(g) Polyarylamides, polyphthaiamides (PPA), preferably PPA having a structure of Nylon 6/6 but with an aryl group instead of the group —(CH₂)₄— in the starting adipic acid;
said polymer having a molecular weight or a number average molecular weight between 500 and 100,000, preferably between 1,000 and 50,000, more preferably between 1,500 and 30,000, and n being an integer such as to obtain the above molecular weight.

4. Use according to claim 1, wherein the polymer is in the powder form having an average size preferably between 0.1 μm and 1,000 μm, more preferably between 50 μm and 300 μm, still more preferably between 1 μm and 30 μm.

5. Use according to claim 1, wherein the polymers are used in amounts in the range 0.1%-50% by weight, preferably 1%-10% by weight, more preferably 2%-7% by weight with respect to the perfluoropolyether oil.

6. Fluorinated lubricant compositions comprising (% by weight):
(A) from 99.9% to 50% of a perfluoropolyether oil or mixture of perfluoropolyether oils, having kinematic viscosity at 20° C. in the range 10-4,000 cSt, preferably 30-2,000 cSt and comprising at least one of the following repeating units: —(CFXO)— wherein X is equal to F, CF₃; —(CF₂CF₂O)—, —(C₃F₆O)—, —(CF₂CF₂CF₂O)—, —(CF₂CF₂CF₂—CF₂O)—, statistically distributed along the polymer backbone;
(B) from 0% to 50%, preferably from 5% to 40% by weight, of one or more thickening agents;
(C) from 0.1% to 50%, preferably from 1% to 10% of the solid polymer defined in claim 1;
optionally
(D) from 0% to 10%, preferably from 1% to 5% based on the total amount of A), B) and C), of at least one additive selected from the antirust, antiwear, antioxidant, pour point depressant additives of the perfluoropolyether oils;
the sum of A), B), C) and D) is 100% by weight.

7. Compositions according to claim 6, wherein component A) is selected from the following classes:
(1) E-O—(CF₂CF(CF₃)O)ₘ(CFXO)_{n′}—CFXO-E′
wherein:
X is equal to F or CF₃;
E and E′, equal to or different from each other, are selected from CF₃,
C₂F₅ or C₃F₇, one fluorine atom of one or both the end groups can be substituted by Cl and/or H;
m′ and n′ are integers such that the m′/n′ ratio is between 20 and 1 ,000, n′ being different from zero; the fluorooxyalkylene units being statistically distributed along the chain and the viscosity of the polymer being in the above range;
(2) C₃F₇O(CF(CF₃)CF₂O)₀-D
wherein:
D is equal to —C₂F5 or —C₃F₇, one fluorine atom of one or both the end groups can be substituted by Cl and/or H;
o′ is an integer such that the viscosity of the polymer is in the above range;
(3) {C₃F₇O(CF(CF₃)CF₂O)p-CF(CF₃)—}₂
wherein:
p′ is an integer such that the viscosity of the polymer is in the above range, one F atom of one or both the end groups C₃F₇ can be substituted by Cl and/or H;
(4) E-O—(CF₂CF(CF₃)O)_{q′}(C₂F₄O)_{r′}(CFXO)_{s′}—CFXO-E′
wherein:
X is equal to F or CF₃;
E and E′, equal to or different from each other, are as above;
q′, r′ and s′ are integers, including zero, and such that the viscosity of the polymer is in the above range;
(5) E-O—(C₂F₄O)_{t′}(CF₂O)_{u′}—CF₂O-E′
wherein:
E and E′, equal to or different from each other, are as above; t′ and u′ are integers such that the t′/u′ ratio is between 0.1 and 5; u′ being different from zero and the viscosity of the polymer being in the above range;
(6) E-O—(CF2CF2CF2O)V-E′
wherein:
E and E′, equal to or different from each other, are as above; v′ is an integer such that the viscosity of the polymer is in the above range;
(7) D-O—(CF₂CF₂O)_{z′}-D′
wherein:
D and D′, equal to or different from each other, are selected between C₂F₅ or C₃F₇, one fluorine atom of one or both the end groups can be substituted by Cl and/or H;
z′ is an integer such that the viscosity of the polymer is in the above range;
(8) E₁O—(CF₂O)ₙ(CF2CF₂O)ₘ(CF₂CF₂CF₂O)ₚ(CF₂CF₂CF₂CF₂O)_{q}—CF₂O-E₂
wherein:
E₁ and E₂ are perfluoroalkyl end groups equal to or different from each other, having formula —(CF₂)_{z}CF₃ wherein z is an integer from O to 3; n, m, p, q are integers, equal to or different from each other, between O and 100 and selected so that the viscosity of the polymer is in the above range and such that the m/n ratio is between 2 and 20, when n is different from zero;
(p+q)/(m+n+p+q) is between 0.05 and 0.2 when (m+n+p+q) is different from zero; n/(n+m+p+q) is between 0.05 and 0.40 when (n+m+p+q) is different from zero.

8. Compositions according to claim 7, wherein the perfluoropolyether oils are those of the classes (1), (4), (5), (8) or their mixtures.

9. Compositions according to claim 6, wherein component B) is selected from the thickeners for perfluoroplyether oils, preferably talc, silica, boron nitride, PTFE, or their mixtures.

10. Compositions according to claim 9, wherein the thickener is silica and is present in amounts generally between 1% and 10% by weight with respect to the total of the composition.

11. Compositions according to claim 9, wherein the thickener is selected from talc, boron nitride or PTFE and is present in amounts between 5% and 40% by weight with respect to the total, more preferably between 5% and 35%.

12. Compositions according to claim 6, wherein component B) is PTFE in powder, more preferably PTFE having an average particle size between 0.01 μm and 0.3 μm.

13. Compositions according to claim 6, wherein component C) is an aromatic polymer as defined in claim 3, used in amounts between 0.1% and 10% by weight, more preferably between 2% and 7% by weight with respect to the perfluoropolyether oil, when C) is used as additive; in larger amounts up to 50% when C) is used in greases wherein component B) is absent.

14. Compositions according to claim 6, wherein component D) is present and is selected from:
antiwear additives, preferably molybdenum sulphide, organic molybdenum compounds, boron nitride, graphite, phosphazene derivatives, more preferably from phosphazene derivatives;
anti-rust additives, preferably the disodic sebacate, functionalized derivatives of carboxylic acids;
or mixtures thereof.

15. A process for preparing the compositions of claim 6, comprising the following steps:
charging of the oil and/or mixture of lubricating oils in a mixer and degassing under vacuum at 60° C. for 2 hours at 0.1 mbar;
gradual addition of components B) and C), previously mixed, until reaching the desired composition;
optional addition of component D);
stirring for at least 8 hours under vacuum;
discharge of the obtained mixture and its refining by passage on tricylindrical refiner;
with the proviso that, when component D) is liquid, it is premixed in the oil(s) before adding the solid components B) and C); when component D) is solid, it is premixed with components B) and C).

16. Use of the compositions of claim 6 as lubricants for high performances, preferably for applications where there is a continuous service temperature higher than 200° C., in the presence of metals in oxidizing environment.

17. Compositions according to claim 6, wherein the lubricant is a grease.
